(19) United States
(12) Patent Application Publication
(10) Pub. No.: US 2022/0378163 A1
(43) Pub. Date: Dec. 1, 2022

(54) Bag With Integrated Lighting System

(71) Applicant: Debbie McGrath, Granite Falls, WA (US)

(72) Inventor: Debbie McGrath, Granite Falls, WA (US)

(21) Appl. No.: 17/570,555

(22) Filed: Jan. 7, 2022

Related U.S. Application Data
(60) Provisional application No. 63/193,852, filed on May 27, 2021.

(51) Int. Cl. A45C 15/06; A45C 3/06; F21V 23/04; F21V 21/32; F21S 9/03

(52) U.S. Cl. CPC A45C 15/06; A45C 3/06; F21V 23/0471; F21V 21/32; F21S 9/037; F21Y 2115/10

(57) ABSTRACT

The present invention relates to a bag with built-in lighting system for illuminating items kept inside the bag. The bag is comprised of motion sensors that detect if the user opens the bag, and accordingly activates the lighting unit placed inside the interior of the bag. Also, the light is automatically turned OFF when the bag is closed. The bag integrated with lighting system allows users to clearly view any item placed inside the bag and eliminates the difficulty of trying to find items in bag under low-light or no-light conditions. Additionally, the lighting system can be integrated into any type of bag including purses, handbags, briefcases, or the like.

### CROSS-REFERENCE TO RELATED APPLICATION

The present application claims priority to, and the benefit of, U.S. Provisional Application No. 63/193,852, which was filed on May 27, 2021, and is incorporated herein by reference in its entirety.

### FIELD OF THE INVENTION

The present invention relates generally to the field of bags and purses. More specifically, the present invention relates to a bag or purse with a built-in lighting system for illuminating items stored in the bag. The bag or purse with a built-in lighting system is configured to turn on a light when a hand is put inside an opened bag. The invention is comprised of motion sensors, lights, processor, battery, solar panels and more elements connected via an internal wiring mechanism to allow the lighting system to be operational when a hand or object is placed in the bag or purse. The invention allows users to view items easily and clearly inside the bag in low ambient light conditions and the present disclosure speaks specifically to this embodiment of the invention. Nonetheless, it is to be appreciated that aspects of the present invention are also equally applicable to other like applications, devices, and methods of manufacture.

### BACKGROUND OF THE INVENTION

By way of background, bags are enclosed receptacles for storing various items. Various kinds of bags including purses, handbags, sling bags, back packs, briefcases and more are used daily. The bags often have compartments to store different kinds of items such as keys, cosmetics, wallets, mobile phones, etc. Some compartments may contain many loose and unorganized items, making it difficult to locate a specific item. This is especially true in low ambient light conditions. During these low ambient light conditions, people may frantically search for a desired item within the bag. In their frustration, people may pour out the bag's contents to find a specific item, leading to additional difficulties and frustration in possibly losing items, in addition to the work of placing all the items back into the bag.

To overcome these difficulties, various kinds of lighting devices can be carried to illuminate a bag's interior. However, these lighting devices are often left behind, or more ironically become lost in the bottom of a bag under the low ambient light conditions when they are so needed. To avoid losing a lighting device in a bag, some people may keep a lighting device powered on inside the bag at all times, thus allowing the user to easily locate the lighting device inside the bag. However, when the lighting device is continually powered on, the device wastes energy and will eventually run out of battery life to render it unusable.

Therefore, there exists a long-felt need for a bag that makes it easy for the users to quickly locate required items stored inside the bag, especially during low ambient light conditions. Additionally, there is a long-felt need for a lighting system that illuminates items kept inside a bag allowing users to clearly see and retrieve the items while eliminating the need to carry a lighting device. Furthermore, there is a long-felt need in the art for a bag with a built-in mechanism for illuminating items inside a bag that allows users to easily see and find items within the bag, thus preventing users from become frustrated when they cannot see or find an item in a bag. There is a long-felt need for a lighting system that prevents lighting devices from being continuously discharged, thereby saving energy and eliminating the need for frequent charging. Finally, there is a long-felt need in the art for a bag that allows users to see the inside of a bag with ease and clarity, while eliminating the need to carry separate lighting devices.

The subject matter disclosed and claimed herein, in one embodiment thereof, comprises a motion-activated light system for a bag. The motion-activated light system is configured to illuminate the internal storage area of a bag for easy viewing of stored items. The light system further comprises a plurality of motion sensors for sensing motion in the internal area of the bag, one or more illuminating units for illuminating the internal area of the bag, a battery or other power supply to provide power to the motion sensors and the illuminating units, a processor to receive motion signal from the motion sensors and transmit an illumination signal to the illuminating unit wherein the motion sensors, the coin battery, the processor and the illuminating units are connected through a wired circuit within the lining of the bag. The motion activated light system is activated when the bag is in an open condition, and a motion such as of a user's hand is detected.

In this manner, the novel bag with built-in lighting system of the present invention accomplishes all the forgoing objectives and provides a convenient and efficient means to illuminate items kept inside a bag, allowing users to clearly view and find items in a bag under low ambient light conditions. The bag with built-in lighting system of the present invention eliminates the need to carry separate lighting devices or to leave the separate lighting device powered on inside a bag. The bag also eliminates the need to frequently charge or replace batteries in the separate lighting devices which are continuously left on.

### SUMMARY OF THE INVENTION

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a motion-activated light system for a bag. The motion-activated light system is configured to illuminate the internal storage area of a bag for easy viewing of stored items, and further comprises a plurality of motion sensors for sensing motion in the internal area of the bag. The bag also has one or more illuminating units for illuminating the internal area of the bag and a battery or other power supply to provide power to the motion sensors and the illuminating units. Further, the bag has a processor to receive a motion signal from the motion sensors and to transmit an illumination signal to the illuminating unit wherein the motion sensors, the battery, the processor and the illuminating units are connected through a wired circuit within the lining of the bag. The motion-activated light system is then activated when the bag is in an open condition and a motion such as that of a user's hand is detected.

In a further embodiment of the present invention, a light-integrated handbag is disclosed. The light-integrated handbag includes a housing, an opening in the housing for creating a cavity and accessing stored items, an illuminating element having an extendable, retractable and flexible arm with a base at one end and one or more LEDs at the opposite end, a plurality of motion sensors positioned near the rim of the opening in the housing and configured for sensing motion in the cavity of the bag, a processor to receive motion signal from the motion sensors and transmitting an illumination signal to the illuminating element and a battery to provide power to the motion sensors and an illuminating element. The illuminating element, battery and processor are further sewn into the lining of the bag, and the illuminating element is configured to illuminate the cavity and any internal storage area of the bag, thereby allowing a user to easily view stored items even in low-ambient light condition. In this manner, a user can easily see and find items stored within the interior of the bag.

In a further embodiment of the present invention, a lighted backpack is disclosed. The lighted backpack includes a solar panel for converting absorbed solar energy into electrical energy, a battery, an illuminating element having an extendable, retractable and flexible arm with a base at one end and one or more lights at the opposite end, a plurality of motion sensors positioned near the fastener of the housing which are configured to sense motion within the housing, and a processor to receive motion signals from the motion sensors and to transmit an illumination signal to the illuminating element. The battery further provides power to the motion sensors and the illuminating element, and can be rechargeable using the solar panel or an integrated USB charging port. The lighted backpack may also include several illuminating elements, with at least one illuminating element for each compartment in the backpack. In an embodiment of the present invention, the illuminating element can be in the form a plurality of separate LEDs sewn around the rim of a bag or within another bag area. The motion sensors allow activation of the LEDs upon detection of motion inside the bag. In some embodiments, the system can comprise one LED, two LEDs, three LEDs or more than three LEDs. The illuminating element may also be comprised of an array of LEDs.

In this manner, the novel bag with built-in lighting system of the present invention accomplishes all the forgoing objectives and provides a convenient and efficient means to illuminate items kept inside a bag to allow users to clearly view and find items in a bag under low ambient light conditions. The bag with built-in lighting system of the present invention eliminates the need to carry separate lighting devices or to leave the separate lighting device powered on inside a bag. The present invention also eliminates the need to frequently charge or replace batteries in the separate lighting devices which are continuously left on.

To the accomplishment of the foregoing and related ends, certain illustrative aspects of the disclosed innovation are described herein in connection with the following description and the annexed drawings. However, these aspects are examples of only a few of the various ways in which the principles disclosed herein can be employed, and are not intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a light-integrated handbag of the present invention in accordance with the disclosed architecture;

FIG. 2 illustrates a close-up perspective view of an illuminating element integrated into one potential embodiment of a light-integrated handbag of the present invention in accordance with the disclosed architecture;

FIG. 3 illustrates a perspective view of one potential embodiment of a light-integrated handbag of the present invention in a closed configuration in accordance with the disclosed architecture;

FIG. 4 illustrates a perspective view showing a user viewing items stored in one potential embodiment of a light-integrated handbag of the present invention in accordance with the disclosed architecture;

FIG. 5 illustrates a perspective view of one potential embodiment of a light-integrated handbag of the present invention with an illuminating element attached in another position inside the handbag in accordance with the disclosed architecture;

FIG. 6 illustrates a block diagram showing connections of essential components of one potential embodiment of a light-integrated handbag of the present invention in accordance with the disclosed architecture;

FIG. 7 illustrates a perspective view of one potential embodiment of a light-integrated handbag of the present invention in accordance with the disclosed architecture; and

FIG. 8 illustrates a perspective view of one potential embodiment of a light-integrated handbag of the present invention in accordance with the disclosed architecture.

### DETAILED DESCRIPTION OF THE INVENTION

The innovation is now described with reference to the drawings, wherein like reference numerals are used to refer to like elements in many of figures and different but logically parallel numerals in other figures. In the following description, for purposes of explanation, numerous specific details are set forth to provide a thorough understanding of the invention. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need for an improved bag that makes it easy for a user to quickly locate required items stored in the bag, especially during low-light conditions. Additionally, there is a long-felt need for a lighting system that illuminates the items kept inside a bag and allows the users to clearly view the items and locate them as and when required, thus eliminating the need to carry a separate lighting device. Furthermore, there is a long-felt need for a bag that has a built-in mechanism for illuminating items inside the bag, and decreases user frustration caused by an inability to locate specific objects inside the bag. There is also a long-felt need in art for a bag with a lighting system that replaces lighting devices that are continually powered on, thus eliminating the need for frequent charging and saving energy of continually powered lighting devices. Finally, there is a long-felt need in the art for a bag that allows users to see inside of the bag with ease and clarity and eliminates the need to carry separate lighting devices.

The present invention, in one exemplary embodiment, comprises a novel light-integrated handbag. The light-integrated handbag includes a housing, an opening in the housing for creating a cavity for storing items, an illuminating element having an extendable, retractable and flexible arm with a base at one end and one or more lights at the opposite end, a plurality of motion sensors positioned near the rim of the opening in the housing and configured for sensing motion in the cavity of the bag, a processor to receive a motion signal from the motion sensors and transmitting an illumination signal to the illuminating element, and a battery to provide power to the motion sensors and the illuminating element. The illuminating element, battery and processor are further sewn into the lining of the handbag for concealment. The illuminating element is also configured to illuminate the cavity and any internal storage area of the bag, thereby allowing a user to easily view the stored items in what would otherwise be difficult to view when in low-light conditions.

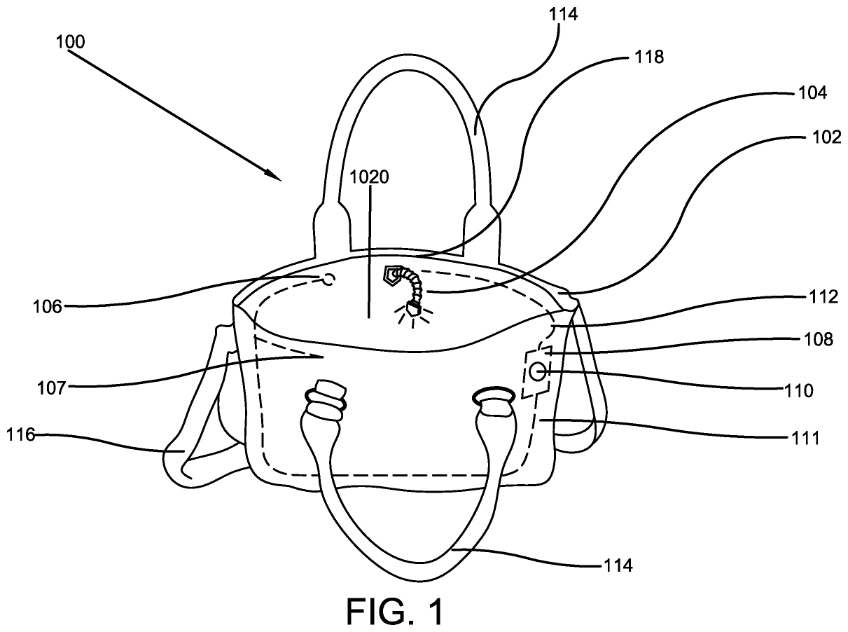

Referring initially to the drawings, FIG. 1 illustrates a perspective view of one potential embodiment of a light integrated handbag 100 of the present invention in accordance with the disclosed architecture. The light integrated handbag 100 has a housing 102 creating a cavity 1020 for storing personal items. The housing 102 is preferably rectangular in shape, however it is contemplated that the shape of the housing 102 includes a variety of other shapes and forms known in the art. The handbag 100 includes an integrated illuminating element 104 positioned near the rim 118 on an interior surface of the housing 102. The illuminating element 104 is preferably an LED with a flexible pipe housing. The illuminating element 104 is sewn to the interior surface of the housing 102, but may also be sewn into or placed under the lining of the housing 102. The illuminating element 104 is configured to illuminate the cavity 1020 and internal storage area of the bag 100 to allow a user to easily view the stored items in a low-light condition. In this manner, the user can more easily see and find items stored within the interior volume.

The interior surface of the housing 102 also has a plurality of motion sensors 106, 107 for detecting when the user is reaching within the interior volume of the handbag 100 to search for and retrieve items. The motion sensors 106, 107 are connected to a built-in microprocessor 111 through an internal wiring circuit 112. Upon detection of user's hand, the motion sensors 106, 107 transmit a signal to the microprocessor 111 to activate the illuminating element 104. When the handbag 100 is closed and no motion is detected by the motion sensors 106, 107, the illuminating element 104 is not illuminated. The motion sensors 106, 107 may be based on one or more of the following motion-detecting technologies: microwave, infrared, radio frequency and ultrasonic, to detect the motion of a user reaching within the handbag 100. The wiring circuit 112 also runs under the lining of housing 102 providing safety to the user and maintaining the aesthetic appeal of the handbag 100.

Electrical power for the illuminating element 104 is provided by a built-in battery 110 integrated into the bag 100 and connected through the wired circuit 112 to the illuminating element 104. The battery 110 may be a 1.5 V coin battery or any other battery known in the art. Further, the battery 110 can be rechargeable or disposable and is securely placed within a fabric battery pouch 108.

The handbag 100 further includes a pair of hand straps 114 positioned on opposite sides of the housing and configured to allow the user to easily carry the handbag 100. The straps 114 can be composed of any of various materials, such as a fabric material, leather, chain or the like. Additionally, a shoulder strap 116 can also be used as a cross-body strap for easy carrying by the user.

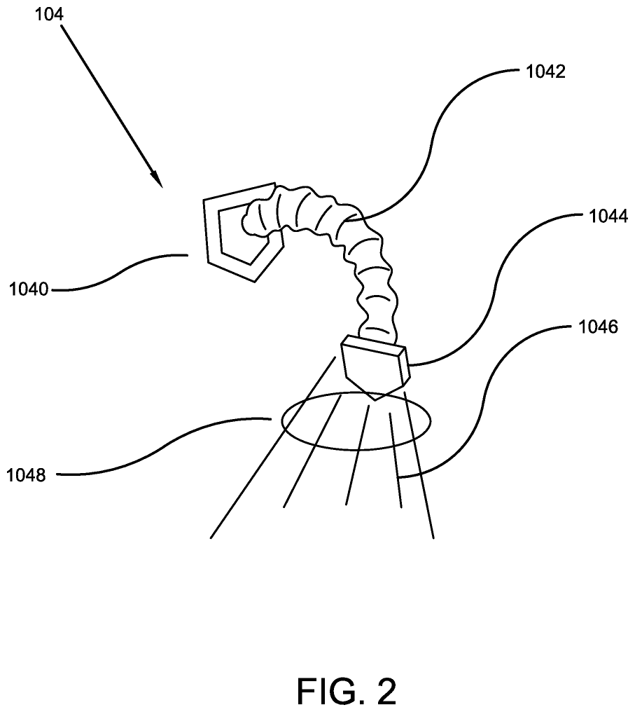

FIG. 2 illustrates a close-up perspective view of an illuminating element 104 integrated into one potential embodiment of a light integrated handbag 100 of the present invention in accordance with the disclosed architecture. The illuminating element 104 has a light unit 1044 (such as an LED) connected to an extendable, retractable and flexible arm 1042. The arm 1042 contains an internal circuit to provide power to the light unit 1044, and is connected to a base 1040 that is sewn to the internal surface of the housing of a handbag. The light unit 1044 provides illumination 1046 to easily view the internal space of the handbag. It should be noted that the illuminating element 104 can be used with any handbag, backpack, luggage or structure of the like.

The flexible arm 1042 and can be oriented in any desired direction, and can be extended to increase in length or be retracted while the handbag 100 is closed. Further, the arm 1042 can have an accordion structure on the outer surface. The arm 1042 contains all necessary wiring to activate the light 1044. The illuminating element 104 is also connected to the microprocessor and the battery 110 such that the motion sensors 106, 107 automatically control operation of the light unit 1044. The light unit 1044 can have a cover to protect the lights of the unit from damage. The light unit 1044 can also be further focused by a lens 1048 such that the illumination 1046 may be white light or colored light depending on the lens. In the alternative, the lens can be clear but different color bulbs can be used to give the same effect. In certain embodiments, the LEDs of the unit 1044 can be formed into one or more arrays of LEDs, wherein each array emits a color known in the art.

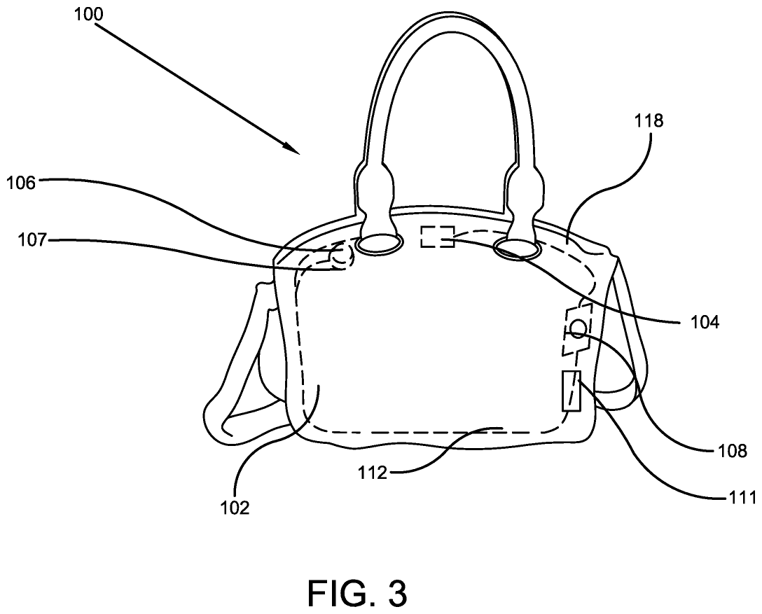

FIG. 3 illustrates a perspective view of one potential embodiment of a light-integrated handbag 100 of the present invention in a closed configuration in accordance with the disclosed architecture. When the handbag 100 is in a closed configuration, the light unit 1044 of the illuminating light 104 is turned OFF automatically since no motion is detected by the motion sensors 106, 107. The processor 111, the battery pouch 108, wired circuit 112 and illuminating unit 104 are sewn to the internal lining of the housing of the bag 100. The illuminating unit 104 is further sewn near the rim 118 of the housing 102.

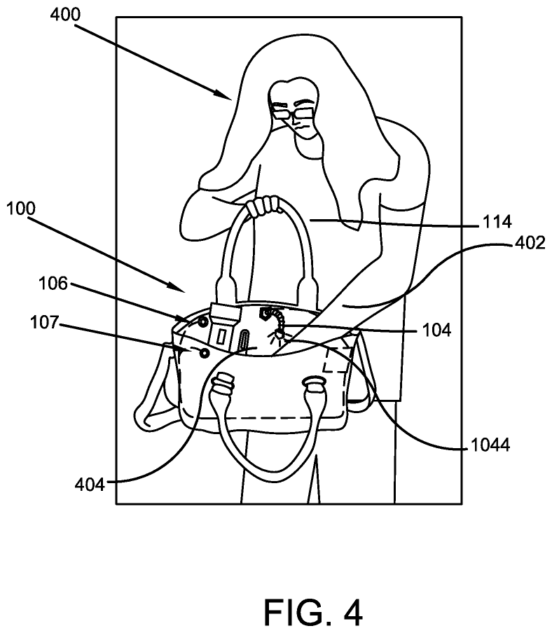

FIG. 4 illustrates a perspective view showing a user viewing items stored in one potential embodiment of a light-integrated handbag 100 of the present invention in accordance with the disclosed architecture. A user 400 can easily hold the handbag 100 using a strap 114. When the user 400 inserts a hand 402 into the bag 100 to find an item 404, the illuminating element 104 activates as the motion sensors 106, 107 detect the motion of the hand 402. The light unit 1044 of the illuminating element 104 illuminates the internal area of the handbag 100 allowing the user 400 to easily sort through items 404 within the housing 102. It is contemplated that the optimal illumination provided by the light unit 1044 depends on the size, materials and shape of the handbag 100. Further, the LEDs 1044 are powered by an internal battery as described earlier herein.

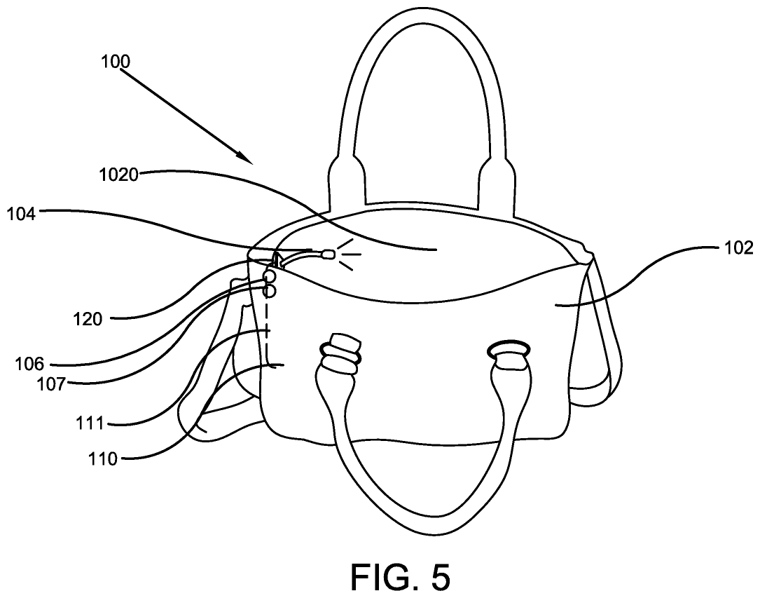

FIG. 5 illustrates a perspective view of on potential embodiment of a light-integrated handbag 100 of the present invention with an illuminating element attached in another position inside the handbag in accordance with the disclosed architecture. In this embodiment, the illuminating element 104 is attached in a side 120 position inside the interior cavity 1020 bag 100, rather than the back position as illustrated in FIG. 1. The position of the light unit 104 is not restricted and can be positioned at any location inside the bag cavity 1020 in such a manner that the light unit 104 illuminates the objects kept inside the bag 100. The various components such as the battery 110, microprocessor 111 and sensors 106, 107 are connected through an internal wiring circuit, as seen in FIG. 1.

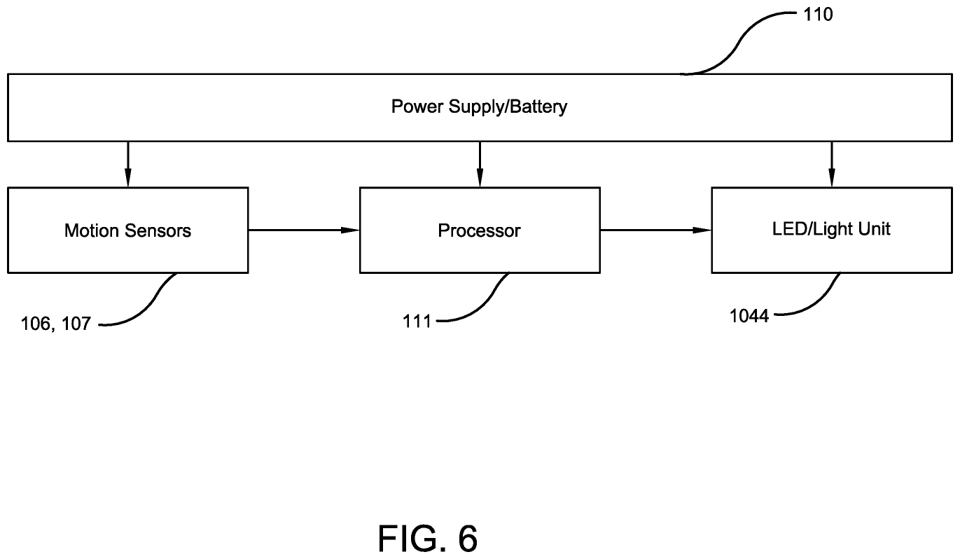

FIG. 6 illustrates a block diagram showing connections of essential components of one potential embodiment of a light-integrated handbag 100 of the present invention in accordance with the disclosed architecture. The components shown in the present embodiment that form the lighting system of the light-integrated handbag include the power supply or battery 110 providing electrical power to motion sensors 106, 107, processor 111 and LEDs or lights 1044. A wired circuit connects the power supply 110 to the other components. The motion sensors 106, 107 are connected to the processor 111 and when motion is sensed, transmit a signal to the processor 111. When the processor 111 receives the signal from the motion sensors 106, 107, an illuminating instruction is transmitted from the processor 111 to the LEDs or lights 1044, thereby allowing the LEDs or lights to illuminate the interior space of the handbag. When the bag 100 is in a closed configuration, the processor 111 does not receive a motion detection signal from the motion sensors 106, 107, and therefore a corresponding illuminating instruction is not transmitted from the processor 111 to the LEDs or light unit 1044. This prevents the LEDs or lights 1044 from illuminating the interior space of the handbag 100.

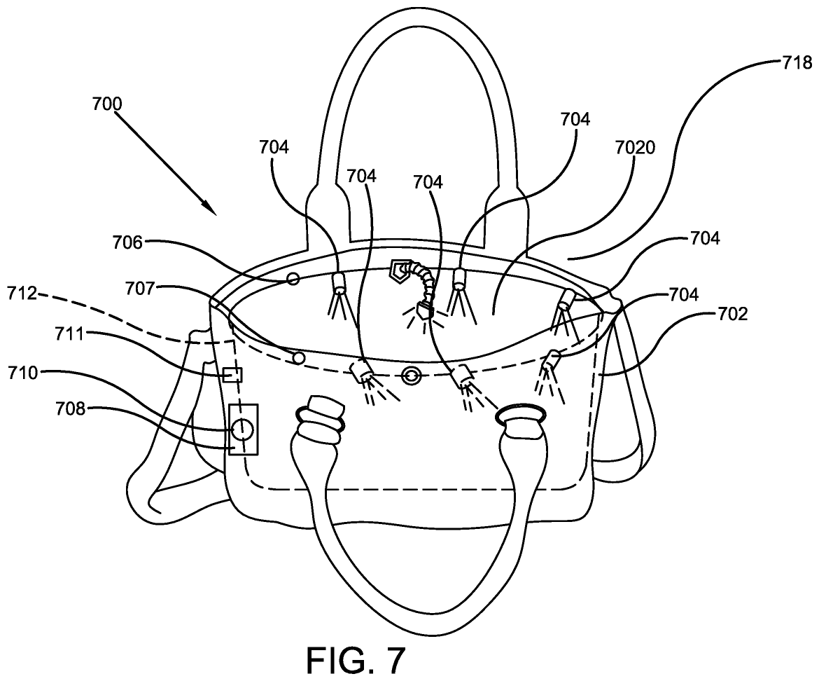

FIG. 7 illustrates a perspective view of one potential embodiment of a light-integrated handbag 100 of the present invention in accordance with the disclosed architecture. The LED strip integrated handbag 700 has a housing 702 creating a cavity 7020 for storing personal items. Preferably, the housing 702 is substantially rectangular in shape. However, it is contemplated that the shape of the housing 702 includes a variety of other shapes and forms. The handbag 700 includes a plurality of LEDs 704 positioned near the rim 718 on an interior surface of the housing 702. The LED lights 704 are sewn to the interior surface of the housing 702. The LEDs 704 are configured to illuminate the cavity 7020 and internal storage area of the bag 700, thereby allowing a user to easily view the stored items in a low-light condition.

The interior surface of the housing 702 has a plurality of motion sensors 706, 707 for detecting when the user is reaching within the interior volume of the handbag 700 to search and pick up items. The motion sensors 706, 707 are connected to a built-in microprocessor 711 through an internal wiring circuit 712. Upon detection of a user's hand, the motion sensors 706, 707 transmit a signal to the microprocessor 711 to activate the LEDs 704. When the handbag 700 is closed and no motion is detected by the motion sensors 706, 707, the LEDs 704 are not illuminated. The wiring circuit 712 runs safely under the lining of housing 702 so it cannot contact a user's hand. For providing electrical power to the LEDs 704, a built-in battery 710 is connected through the wired circuit 712 to the LEDs 104. The battery 710 can be a 1.5 V coin battery or any other battery known in the art. Further, the battery 710 can be rechargeable or disposable and is securely placed within a fabric pocket/pouch 708.

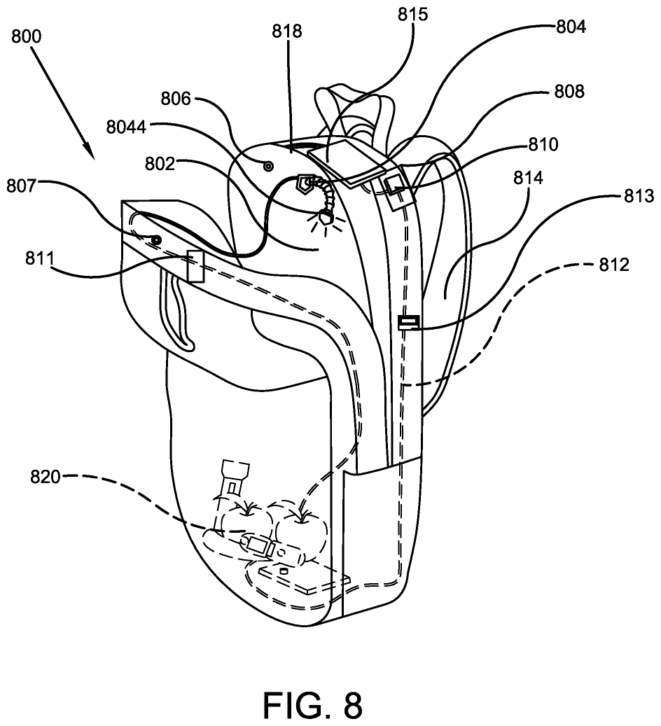

FIG. 8 illustrates a perspective view of one potential embodiment of a light-integrated handbag of the present invention in accordance with the disclosed architecture. The backpack 800 comprises a housing 802 forming an interior volume therein. The housing 802 includes an opening that provides access to the interior volume to store items 820. A fastener 818 selectively opens and closes access to the interior volume. The housing 802 further includes at least one strap 814 attached thereon configured to be wrapped around a user's shoulder to support the backpack 800.

The housing 802 includes an illuminating element 804 positioned within the interior volume of the housing 802, wherein the illuminating element 804 provides illumination within the interior volume to allowing a user to easily view the contents of the backpack in what might otherwise be low-light conditions if the user were to rely only on ambient lighting. With the illumination, a user can easily view and find items stored within the interior volume even when ambient lighting conditions are poor. The illuminating element 804 uses at least one light-emitting diode (LED) 8044 that provides sufficient illumination in the interior space of the backpack 800 to allow a user to see and retrieve items of interest. In differing embodiments, the LED 8044 may also be a plurality of colors known in the art.

A plurality of motion sensor 806, 807 are connected to a processor 811 and detect motion, wherein the processor activates the LED 8044 when the motion is detected by the motion sensors 806, 807. A battery 810 is securely stored in a battery pouch/pocket 808 and provides power to the LED 8044. A waterproof solar panel 815 is attached to the housing 802 and is used for charging the battery 810. A USB charging port 813 can also be used for charging the battery 810. Further, a wired circuit 812 connects all electrical components of the backpack 800.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “light-integrated handbag”, “bag with built-in lighting system”, “handbag” and “bag” are interchangeable and refer to the light-integrated handbag 100, 700, 800 of the present invention.

Notwithstanding the forgoing, the light-integrated handbag 100, 700, 800 of the present invention can be of any suitable size and configuration as is known in the art without affecting the overall concept of the invention, provided the size and configuration accomplishes the above-stated objectives. One of ordinary skill in the art will appreciate that the size, configuration, and material of the light integrated handbag 100, 700, 800 as shown in the FIGS. are for illustrative purposes only, and that many other sizes and shapes of the light-integrated handbag 100, 700, 800 are well within the scope of the present disclosure. Although the dimensions of the light-integrated handbag 100, 700, 800 are important design parameters for user convenience, the light-integrated handbag 100, 700, 800 may be of any size and configuration that ensures optimal performance during use and/or suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A bag with built-in lighting system comprising:
a housing comprising an interior lining;
a plurality of motion sensors;
at least one light;
a rechargeable battery;
a processor; and
a wired circuit running under the interior lining of the housing connecting the plurality of motion sensors, the at least one light, the battery, and the processor, wherein the processor is configured to receive a first signal from at least one of the plurality of motion sensors and send a second signal to the at least one light.

2. The bag with built-in lighting system of claim 1, wherein the plurality of motion sensors may be comprised of one or more of the following: a microwave sensor, an infrared sensor, a radio frequency sensor and an ultrasonic sensor.

3. The bag with built-in lighting system of claim 1, wherein the at least one light is an LED light.

4. (canceled)

5. A bag with built-in lightning system comprising:
a housing for storing an item, the housing having an opening to access the item;
an illuminating element comprised of a flexible arm having a pair of opposite ends and an accordion structure on an outer surface of the flexible arm allowing the flexible arm to extend and retract, wherein a first end of the pair of opposite ends comprises a base and an opposite end of the pair of opposite ends has at least one light;
a plurality of motion sensors;
a battery; and
a processor configured to receive a first signals from the plurality of motion sensors and send a second signal to the at least one light.

6. (canceled)

7. The bag with built-in lightning system of claim 5, wherein the base is sewn into the housing near the opening.

8. The bag with built-in lightning system of claim 7, wherein the at least one light is an LED light.

9. (canceled)

10. The bag with built-in lightning system of claim 7, further comprising a plurality of LED's distributed around the opening of the housing.

11. The bag with built-in lightning system of claim 10, wherein the plurality of LED's are comprised of a plurality of different colors.

12. The bag with built-in lightning system of claim 5, wherein the illuminating element comprises a lens so that a light can be focused and colored.

13. The bag with built-in lightning system of claim 5, wherein the plurality of motion sensors may be comprised of one or more of the following: a microwave sensor, an infrared sensor, a radio frequency sensor and an ultrasonic sensor.

14. The bag with built-in lightning system of claim 5, wherein the battery is a rechargeable battery.

15. A lighted backpack comprised of:
a solar panel;
a rechargeable battery;
a USB charging port for charging the rechargeable battery;
an illuminating element comprised of a retractable and flexible arm having a pair of opposite ends and an accordion structure on an outer surface of the retractable and flexible arm, wherein a base is positioned at a first of the pair of opposite ends and at least one LED light is positioned at a second of the pair of opposite ends;
a plurality of motion sensors; and
a processor configured to receive a first signal from the plurality of motion sensors and send a corresponding signal to the plurality of lights.

16. (canceled)

17. (canceled)

18. (canceled)

19. The lighted backpack of claim 15, wherein the plurality of motion sensors may be comprised of one or more of the following: a microwave sensor, an infrared sensor, a radio frequency sensor and an ultrasonic sensor.

20. (canceled)
